(19) United States
(12) Patent Application Publication
(10) Pub. No.: US 2017/0187219 A1
(43) Pub. Date: Jun. 29, 2017

(54) Wireless charging system

(71) Applicant: INTEL CORPORATION, Santa Clara, CA (US)

(72) Inventors: Don J. Nguyen, Portland, OR (US); Songnan Yang, San Jose, CA (US); Sofia C. HAO, Beaverton, OR (US)

(21) Appl. No.: 14/757,558

(22) Filed: Dec. 24, 2015

(51) Int. Cl. H02J 7/02; H02J 7/04

(52) U.S. Cl. CPC H02J 7/025; H02J 7/04

(57) ABSTRACT

A charging system may be provided that include an adapter to receive an external power and to provide an output voltage, and a charging device to receive the output voltage and to provide a wireless power. The adapter may adjust the output voltage based on feedback information. The charging device may include a power amplifier to receive the output voltage directly from the adapter, a power transmitter to transmit the wireless power, a wireless communication device to receive power information from an external electronic device, and a feedback device to provide a feedback signal or feedback information to the adapter based on the power information.

### BACKGROUND

1. Field

Embodiments may relate to wireless charging of an electronic device or apparatus.

2. Background

A wireless charger (or wireless charging device) may provide a charging mechanism for charging one or more compatible devices. The wireless charger may be connected to a power source, but may provide a wireless charge to an electronic device (or apparatus) when the device (or apparatus) is provided on top of the wireless charger or provided in close proximity to the wireless charger.

### BRIEF DESCRIPTION OF THE DRAWINGS

Arrangements and embodiments may be described in detail with reference to the following drawings in which like reference numerals refer to like elements and wherein:

FIG. 1 shows a block diagram of a wireless power transfer system according to an example arrangement;

FIG. 2 shows a wireless charging system according to an example arrangement;

FIG. 3 shows an adapter and charging device according to an example embodiment;

FIG. 4 is a flowchart showing operations according to an example embodiment;

FIG. 5 shows an adapter and charging device according to an example embodiment; and

FIG. 6 is a flowchart showing operations according to an example embodiment;

### DETAILED DESCRIPTION

In the following description, numerous specific details are set forth. However, it is understood that embodiments may be practiced without these specific details. In other instances, well-known circuits, structures and techniques have not been shown in detail in order not to obscure an understanding of this description.

References to “one embodiment,” “an embodiment,” “example embodiment,” “various embodiments,” etc., indicate that the embodiments may include particular features, structures, or characteristics, but not every embodiment necessarily includes the particular features, structures, or characteristics. Further, some embodiments may have some, all, or none of the features described for other embodiments.

As used hereinafter, the words “wireless power” may be used to mean any form of energy associated with electric fields, magnetic fields, electromagnetic fields, or otherwise that is transmitted from a transmitting device to a receiving device without the use of physical conductors.

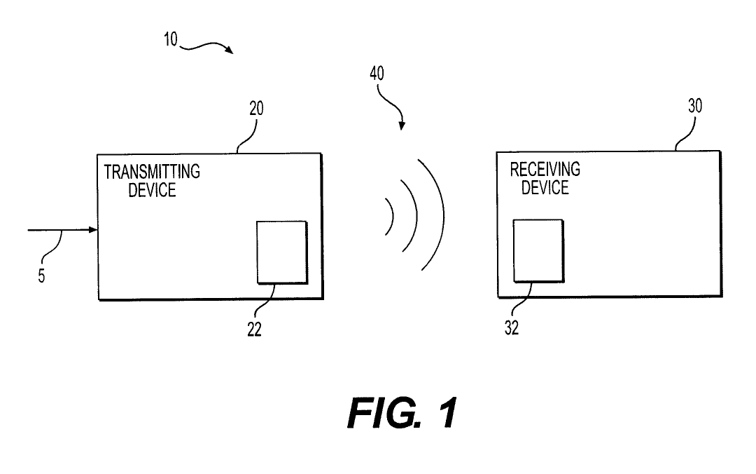

FIG. 1 shows a block diagram of a wireless power transfer system according to an example arrangement. Other arrangements and configurations may also be provided.

FIG. 1 shows a wireless power transfer system 10 that includes a transmitting device 20 and a receiving device 30. Input power 5 (from an external power source) may be provided to the transmitting device 20 for generating a radiated field 40 for providing a power transfer. The receiving device 30 may couple to the radiated field 40 to receive power.

The transmitting device 20 may include a transmitting unit 22 for providing a means for energy transmission, and the receiving device 30 may include a receiving unit 32 for providing a means for energy reception. The transmitting unit 22 may include induction coils, an antenna, etc., for example. The receiving unit 30 may include induction coils, an antenna, etc., for example.

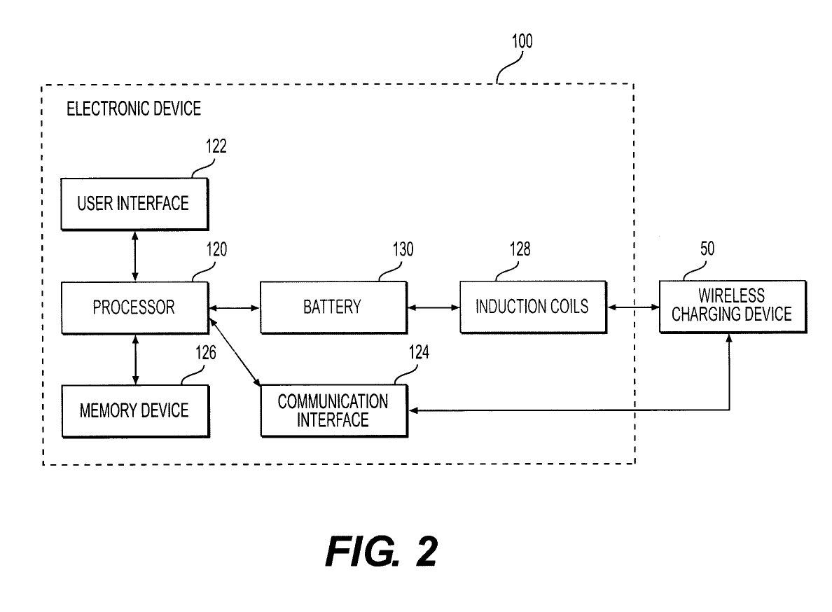

FIG. 2 shows a wireless charging system according to an example arrangement. Other arrangements and configurations may also be provided.

FIG. 2 shows a wireless charging system that include a wireless charging device 50 (or wireless charger) and an electronic device 100 (or electronic apparatus). The wireless charging device 50 may correspond to the transmitting device 20 (FIG. 1), and the electronic device 100 may correspond to the receiving device 30 (FIG. 1).

The electronic device 100 may include a processor 120, a memory device 126 (or memory), a user interface 122, a communication interface 124, a battery 130, and/or a plurality of induction coils 128. The electronic device 100 may be any one of a wide variety of battery powered devices including mobile terminals, such as personal digital assistants (PDAs), pagers, mobile televisions, mobile telephones, smartphones, gaming devices, laptop computers, tablet computers, cameras, camera phones, video recorders, audio/video players, radios, global positioning system (GPS) devices, navigation devices, and/or any combination of the aforementioned.

The processor 120 (and/or co-processors or any other processing circuitry assisting or otherwise associated with the processor 120) may be in communication with the memory device 126 via a bus for passing information among components of the electronic device 100. The memory device 126 may include, for example, one or more volatile and/or non-volatile memories. For example, the memory device 126 may be an electronic storage device (e.g., a computer readable storage medium) comprising gates configured to store data (e.g., bits) that may be retrievable by a machine (e.g., a computing device such as the processor 120). The memory device 126 may be configured to store information, data, content, applications, instructions, and/or the like for enabling the apparatus to carry out various functions.

The processor 120 may be embodied in a number of different ways. For example, the processor 120 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in at least one embodiment, the processor 120 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

The communication interface 124 may be any means such as a device or circuitry embodied in either hardware or a combination of hardware and software that is configured to receive and/or transmit data from/to a network and/or any other device or module in communication with the electronic device 100. The communication interface 124 may include, for example, an antenna (or multiple antennas) and supporting hardware and/or software for enabling communications with a wireless communication network. Additionally or alternatively, the communication interface 124 may include the circuitry for interacting with the antenna(s) to cause transmission of signals via the antenna(s) or to handle receipt of signals received via the antenna(s). In some environments, the communication interface 124 may alternatively or also support wired communication. For example, the communication interface 124 may include a communication modem and/or other hardware/software for supporting communication via cable, digital subscriber line (DSL), universal serial bus (USB) and/or other mechanisms.

The communication interface 124 may also be configured to communicate with the wireless charging device 50, either directly or over a network. Additionally or alternatively, the electronic device 100 may communicate with wireless charging device 50 via radio frequency signal provided by the induction coil(s) 128. In some embodiments, near field magnetic resonance may be used to transmit power between the wireless charging device 50 and the electronic device 100. The wireless charging device 50 may be a wireless device, configured to charge other wireless devices from its power supply.

The electronic device 100 may include a user interface 122 that may be in communication with the processor 120 to receive an indication of a user input and/or to cause provision of an audible, visual, mechanical or other output to the user. The user interface 122 may include, for example, a keyboard, a mouse, a joystick, a display, a touch screen(s), touch areas, soft keys, a microphone, a speaker, or other input/output mechanisms. Alternatively or additionally, the processor 120 may comprise user interface circuitry configured to control at least some functions of one or more user interface elements such as, for example, a speaker, ringer, microphone, display, and/or the like.

The electronic device 100 may include a battery 130, configured to store, and in turn, provide power to various components of the electronic device 100. The battery 130 may be coupled to the inductive coil(s) 128 in order to receive a charge. The inductive coil(s) 128 may be configured to be operable to provide power to charge the battery 130. In this regard, when the electronic device 100 is placed on or adjacent to a wireless charging device 50, such that the inductive coil(s) 128 is in close proximity to an inductive coil of the wireless charging device 50 such that the inductive coil(s) 128 is in the electromagnetic field of the inductive coil of the wireless charging device 50, the two coils may form an electrical transformer. Placing the electronic device 100 on the wireless charging device 50 in different positions may impact strength of the electromagnetic field between the coils and therefore may affect the rate at which battery 130 charges.

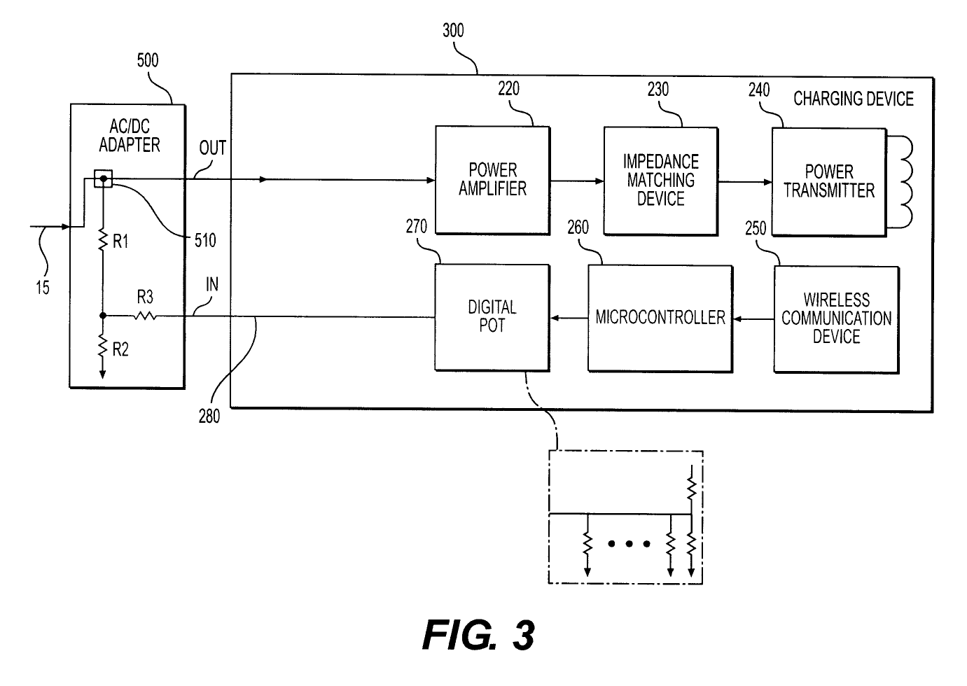

FIG. 3 shows an adapter and a charging device according to an example embodiment. Other embodiments and configurations may also be provided.

FIG. 3 shows a charging device 300 and an AC/DC adapter 500. The adapter 500 may receive an external power 15 from an external power source. For example, the adapter 500 may receive an AC signal from an external power source. The charging device 300 may correspond to the wireless charging device 50 (FIG. 2) and/or the transmitting device 20 (FIG. 1). The charging device 300 may be or may include a charging mat (or charging pad) to charge an electronic device, such as the electronic device 100 (FIG. 2) and/or the receiving device 30 (FIG. 1). The charging device may also be called a wireless power charging device.

FIG. 3 is a block diagram showing components of the charging device 300. The charging device 200 may include a power amplifier (PA) 220, an impedance matching device 230, and a power transmitter 240 (or power transmitting device). As shown in FIG. 3, the charging device 300 does not include a voltage regulator between the adapter 500 and the power amplifier 220. In at least one embodiment, the power transmitter 240 may include the power amplifier and the impedance matching device.

The charging device 300 may also include a wireless communication device 250, a microcontroller 260 (or controller) and a digital potentiometer (POT) 270.

The impedance matching device 230 may also be considered a Z-match device. The power transmitter 240 may also be considered an auto tune relay.

FIG. 3 also shows the adapter 500 to receive the external power 15 and to provide an output power. The adapter 500 may be an alternate current/direct current (AC/DC) adapter. The adapter 500 may be called an AC/DC adapter. The adapter 500 may receive AC power from an external power source (the external power 15) and provide a DC voltage (or DC signal) to the charging device 300. The adapter 500 may be considered an adjustable adapter since the output voltage is adjustable. In at least one embodiment, the adapter 500 may be an adapter that is enabled with Intel® Adaptive Mobile Power System (iAMPS) technology. The iAMPS compliant power adapter may have an output voltage that is controllable.

In at least one embodiment, the adapter 500 may provide a DC voltage signal (or output voltage). The adapter 500 may adjust the DC voltage signal based on feedback information.

In at least one embodiment, the digital potentiometer 270 (or digital POT) is used to directly control the output voltage of the adapter 500. In this embodiment, a voltage regulator is not used (and may not be provided) which may result in reducing power dissipation and thermal complexity.

The charging device 300 may receive the output voltage (or DC voltage signal) from the adapter 500, and may provide a wireless power based on the output voltage. The charging device may include a power transmitter, a wireless communication device and a feedback device. The feedback device may receive power information and provide a feedback signal (or feedback information) to the adapter based on the power information. The adapter may adjust the output voltage based on the feedback signal (or feedback information). In this embodiment, the feedback device may include a microcontroller (or controller) and a digital potentiometer. The controller may receive the power information (from an external electronic device) and may provide a command to the digital potentiometer based on the power information. The digital potentiometer may provide the feedback (or feedback signal) to the adapter. The feedback (or feedback signal) may be an analog signal that is provided from the digital potentiometer to the adapter.

As shown in FIG. 3, the charging device 300 includes the power amplifier 220, the impedance matching device 230, the power transmitter 240, the wireless communication device 250, the microcontroller 260 and the digital potentiometer 270. The charging device 300 does not include a voltage regulator. The lack of the voltage regulator within the charging device 300 may help avoid problems of power consumption (or heat dissipation) by the voltage regulator. The charging device 300 may include at least one connector to the power amplifier without using a voltage regulator.

The adapter 500 may receive AC power (i.e., the external power 15) from an external power source and provide a DC voltage (or DC voltage signal) to the power amplifier 220 without the DC voltage being provided through a voltage regulator. The DC voltage signal from the adapter 500 may be adjusted (or changed) based on feedback (or feedback information). An analog feedback signal (or feedback information) may be provided from the digital potentiometer 270 to the adapter 500, via the signal line 280.

FIG. 3 shows the AC/DC adapter 500 receives an analog signal (from the digital POT) on the signal line 280. The analog signal may be received at an input terminal IN. FIG. 3 shows the AC/DC adapter 500 may include a voltage divider circuit (that includes resistors R1 and R2) and a resistor R3 between the voltage divider and the input terminal IN.

One end of the resistor R1 may be coupled to components 510, which may be any of a number of circuit components. The external signal 15 may also be provided to an input of the components 510. An output of the components 510 may be provided to an output terminal OUT of the AC/DC adapter 500.

The power amplifier 220 may receive the DC signal from the output terminal OUT of the adapter 500 and may output an AC signal to the impedance matching device 230. The impedance matching device 230 may receive the AC signal from the power amplifier 220 and may provide (or output) the AC signal to the power transmitter 240. The impedance matching device (or circuit) may match impedance as seen from an induction coil (or transmitting coil). The power transmitter 240 may transmit the wireless power to the electronic device 100.

In at least one embodiment, the power transmitter 240 may include induction coils in order to wirelessly provide power to another electronic device. For ease of discussion, another electronic device may correspond to the electronic device (FIG. 2) and/or the receiving device.

The power amplifier may receive the output voltage directly from the adapter, and may provide an AC signal based on the received output voltage. The power transmitter may transmit the wireless power based at least in part on the AC signal.

The charging device 300 may also communicate with the electronic device 100 (FIG. 2). For example, the wireless communication device 250 may receive power information from the electronic device 100. The power information may be information or data related to whether power of the electronic device should be increased or decreased. As one example, the wireless communication device 250 may be a Bluetooth enabled device. The power information may be information to increase the wireless power from the power transmitter. The power information may be information to decrease the wireless power from the power transmitter.

The wireless communication device 250 may provide the received information to the microcontroller 260 (or controller). The microcontroller 260 may communicate with the digital potentiometer 270 (or digital POT) via an 12C bus.

In at least one embodiment, the microcontroller 260 (or controller) may determine that a different power is to be provided to the electronic device 100 based on power information received by the wireless communication device 250. The microcontroller 260 may then provide a command to the digital potentiometer 270 to select a specific pull-down resistor, for example.

The digital POT 270 may include a programmable resistor divider. The command from the microcontroller 260 may select a specific pull-down resistor from the programmable resistor divider, and the digital POT 270 may provide an analog signal on signal line 280 to the input terminal of the AC/DC adapter 500. When the amplitude of the analog signal is high, then the AC/DC adapter 500 may operate to provide a higher DC voltage at the output terminal OUT. On the other hand, when the amplitude of the analog signal is low, then the AC/DC adapter 500 may operate to provide a lower DC voltage at the output terminal OUT.

FIG. 3 shows one example of the digital POT including a programmable resistor divider. A first resistor may be fixed between a specific voltage (such as 3.3 volts) and a common node. Additionally, a plurality of pull-down resistors may be coupled between the common node and ground. The command from the microcontroller may select a specific pull-down resistor which corresponds to the selected analog signal to be provided from the common node. The microcontroller provides the command in order to provide a specific analog signal on the signal line 280. The specific analog signal may have a specific amplitude.

Accordingly, the digital POT 270 provides a feedback signal (analog signal) to the adapter 500, which is to appropriately adjust (or change) the output voltage of the adapter 500. The microcontroller 260 may provide the command to the potentiometer 270, and the potentiometer 270 may provide a feedback signal (or control signal) to the adapter 500. The feedback signal provided to the adapter 500 may be used to appropriately adjust (or change) the output voltage of the adapter 500.

In at least one embodiment, the digital potentiometer 270 may provide feedback information to the adapter 500 via the signal line 280. The feedback information may be provided within an analog signal (or as the analog signal). The feedback information may be information on changing or adjusting voltage of the power to be transmitted to the electronic device 100. In at least one embodiment, the feedback information may be used to adjust a voltage of the DC signal output from the adapter 500. This may adjust (or change) the voltage transmitted from the power transmitter 240. The information received at the wireless communication device 250 may be used in order to adjust (or change) power output from the power transmitter 240.

More specifically, the adapter 500 may receive the analog signal from the digital potentiometer 270, and the adapter 500 may adjust (or change) a DC voltage (or DC signal) output from the adapter 500 based on feedback information (received as part of the analog signal). For example, based on the analog signal having a high amplitude, the adapter 500 (that includes the resistors R1, R2, R3) may increase a voltage of the DC signal output from the adapter 500 (and provided to the power amplifier 220). In at least one embodiment, based on the analog signal having a low amplitude, the adapter 500 may decrease a voltage of the DC signal output from the adapter 500 (and provided to the power amplifier 220). Accordingly, the power transmitted from the power transmitter 240 (such as to the electronic device) may be adjusted (or changed) based on a feedback signal that is provided as an analog signal from the potentiometer 270 to the adapter 500. The power transmitter may provide the wireless power based at least in part on the DC voltage signal.

In at least one embodiment, the DC signal output from the adapter 500 is provided to the power amplifier 220 without being provided at a voltage regulator. In at least one embodiment, the voltage regulator is not provided or is not used in the charging device 300.

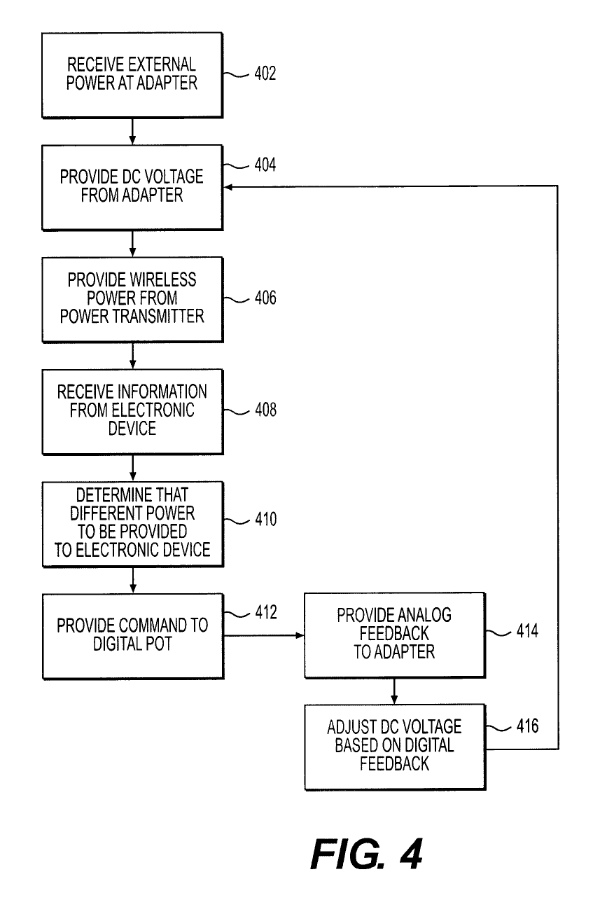

FIG. 4 is a flowchart showing operations according to an example embodiment. Other operations, orders of operations and embodiments may also be provided.

More specifically, FIG. 4 shows a plurality of operations that may be performed by the adapter and charging device structure of FIG. 3, for example.

Operation 402 may include to receive an external power at an adapter. For example, the AC/DC adapter 500 may receive the external power 15 from an external power source.

Operation 404 may include to provide a DC voltage from the adapter. For example, the AC/DC adapter 500 may provide a DC voltage to the charging device 30.

Operation 406 may include to provide wireless power from a power transmitter. For example, the power transmitter 240 may provide the wireless power to a receiving device, such as an electronic device.

Operation 408 may include to receive information from an electronic device. For example, the wireless communication device 250 may receive power information from the electronic device.

Operation 410 may include to determine that a different power is to be provided to the electronic device. For example, the microcontroller 260 may determine (from the received power information) that a different power is to be provided to the electronic device.

Operation 412 may include to provide a command. For example, the microcontroller 260 may provide a command to the digital POT 270 regarding changing power to the electronic device. The microcontroller 260 may select a specific pull-down resistor which may result in a specific amplitude of the analog signal.

Operation 414 may include to provide an analog feedback to the adapter. For example, the digital POT 270 may provide an analog signal (or feedback) to the adapter 500.

Operation 416 may include to adjust the DC voltage output from the adapter based on the analog signal (or feedback). For example, the AC/DC adapter 500 may adjust the DC voltage that is to be output (from the AC/DC adapter 500) based on an amplitude of the analog signal (or analog signal).

Operations may then return to operation 404 where the DC voltage is output from the AC/DC adapter 500 to the charging device 300. The other operations of the flow chart may then be provided.

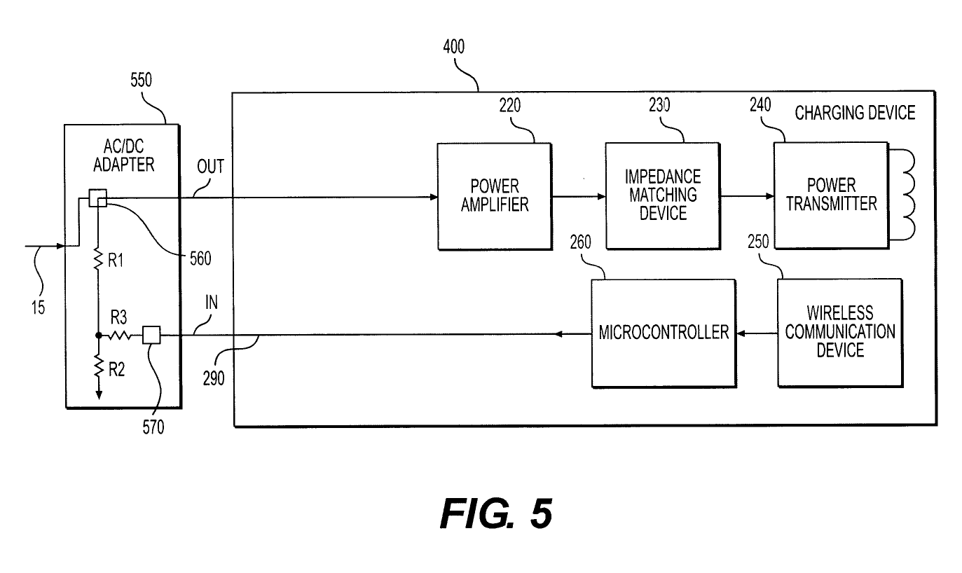

FIG. 5 shows an adapter and a charging device according to an example embodiment. Other embodiments and configurations may also be provided.

FIG. 5 shows a charging device 400 and an AC/DC adapter 550. The adapter 550 may receive the external power 15 from an external power source. For example, the adapter 550 may receive an AC signal from an external power source.

FIG. 5 shows the charging device 400 that includes features of the charging device 300. For ease of discussion, similar components within the charging device may not be further described.

In at least one embodiment, the microcontroller 260 (or controller) is used to directly control the output voltage of the adapter 550. The microcontroller 260 may provide a digital feedback signal (or digital signals) to the adapter 550 using an I2C connector, for example. In this embodiment, a voltage regulator and the digital potentiometer are not used (and may not be provided) which may result in reducing power dissipation and thermal complexity.

In at least one embodiment, the adapter 550 may provide a DC voltage signal (or output voltage). The adapter 550 may adjust the DC voltage signal based on feedback information (or feedback signal).

The charging device 400 may receive the output voltage from the adapter 550, and may provide a wireless power based at least on the output voltage (or DC voltage signal). The charging device may include a power transmitter, a wireless communication device and a feedback device (such as the microcontroller). The feedback device may receive power information and provide a feedback signal (or feedback information) to the adapter based on the power information. The adapter may adjust the output voltage (or DC voltage signal) based on the feedback signal (or feedback information). In this embodiment, the feedback device may include a microcontroller (or controller) to receive the power information (from an external electronic device) and to provide the feedback signal to the adapter based on the power information. The feedback signal (or feedback information) may be a digital signal that is provided from the controller to the adapter. A connector may be between the microcontroller and the adapter, and the digital signal may be provided from the microcontroller to the adapter via the connector.

As shown in FIG. 5, the charging device 400 includes the power amplifier 220, the impedance matching device 230, the power transmitter 240, the wireless communication device 250, and the microcontroller 260. The charging device 400 does not include the digital potentiometer 270 and a voltage regulator. The lack of the digital potentiometer may help to reduce cost and size of materials. The charging device 400 may include at least one connector to the power amplifier without using a voltage regulator.

The adapter 550 may receive AC power (i.e., the external power 15) from an external power source and provide a DC voltage (or DC voltage signal) to the power amplifier 220 without being provided through a voltage regulator. The DC voltage output from the adapter 550 may be adjusted (or changed) based on feedback (or feedback information). A digital feedback signal (or feedback information) may be provided from the microcontroller 260 to the adapter 550 via a signal line 290.

FIG. 5 shows the AC/DC adapter 550 receives a digital signal (from the microcontroller) on a signal line 290. In at least one embodiment, the signal line 290 may be an I2C bus. The signal line 290 is connected to the input terminal IN.

In at least one embodiment, the digital signal may be a pulse-width modulated signal (PWM) from the microcontroller 260.

FIG. 5 shows the AC/DC adapter 550 may include a digital-to-analog converter 570, a voltage divider circuit (that includes resistors R1 and R2) and a resistor R3 between the voltage divider and the digital-to-analog converter 570. The digital-to-analog converter 570 may convert the digital signal received at the input terminal IN into an analog signal. The conversion into the analog signal may be based on the duty cycle of the received digital signal. For example, when the digital signal has a large duty cycle, then the converted analog signal may have a larger amplitude. On the other hand, when the digital signal has a smaller duty cycle, then the converted analog signal may have a smaller amplitude.

One end of the resistor R1 may be coupled to components 560, which may be any of a number of circuit components. The external signal 15 may also be provided to an input of the components 560. An output of the components 560 may be provided to an output terminal OUT of the AC/DC adapter 500. Accordingly, the signal output from the output terminal OUT may be dependent on the duty cycle of the digital signal at the input terminal IN.

The power amplifier 220 may receive the DC signal from the adapter 550 and may adjust the DC signal output to the impedance matching device 230. The impedance matching device 230 may receive the DC signal from the power amplifier 220 and may provide the AC signal to the power transmitter 240. The power transmitter 240 may transmit the wireless power to the electronic device 100 (based at least in part of the DC voltage signal).

The power amplifier may receive the output voltage (or DC voltage signal) directly from the adapter, and may provide an AC signal based on the received output voltage. The power transmitter may transmit the wireless power based at least in part on the AC signal.

The wireless communication device 250 may receive power information from the electronic device 100. The power information may be information or data related to whether power of the electronic device should be increased or decreased. The power information may be information to increase the wireless power from the power transmitter. The power information may be information to decrease the wireless power from the power transmitter. The wireless communication device 250 may provide the received information to the microcontroller 260 (or controller).

In at least one embodiment, the microcontroller 260 (or controller) may determine that a different power is to be provided to the electronic device 100 based on power information received by the wireless communication device 250. The microcontroller 260 may provide a feedback signal (digital signal) via the signal line 290 to the input terminal IN of the adapter 550. The adapter 550 may then appropriately adjust (or change) the output voltage of the adapter 550. The feedback signal may contain feedback information. The feedback signal provided to the adapter 550 may be used to appropriately adjust (or change) the output voltage of the adapter 550.

In at least one embodiment, the microcontroller 260 may provide feedback information (or feedback signal) to the adapter 550. The feedback information may be provided within a digital signal. The feedback information may be information on changing or adjusting voltage of the power to be transmitted to the electronic device 100. In at least one embodiment, the feedback information may be used to adjust a voltage of a DC signal output from the adapter 550. This may adjust (or change) the voltage transmitted from the power transmitter 240. The information received at the wireless communication device 250 may be used in order to adjust (or change) power output from the power transmitter 240.

More specifically, the adapter 550 may receive the digital signal from the microcontroller 260, and the adapter 550 may adjust (or change) a DC voltage (or DC signal) output from the adapter 550 based on feedback information (received as part of the digital signal). For example, based on the received feedback information (or feedback signal), the adapter 550 may increase a voltage of the DC signal output from the adapter 550 (and provided to the power amplifier 220). In at least one embodiment, based on the received feedback information, the adapter 550 may decrease a voltage of the DC signal output from the adapter 550 (and provided to the power amplifier 220). Accordingly, the power transmitted from the power transmitter 240 (such as to the electronic device) may be adjusted (or changed) based on a feedback signal (or feedback information) that is provided as a digital signal from the microcontroller 260 to the adapter 550.

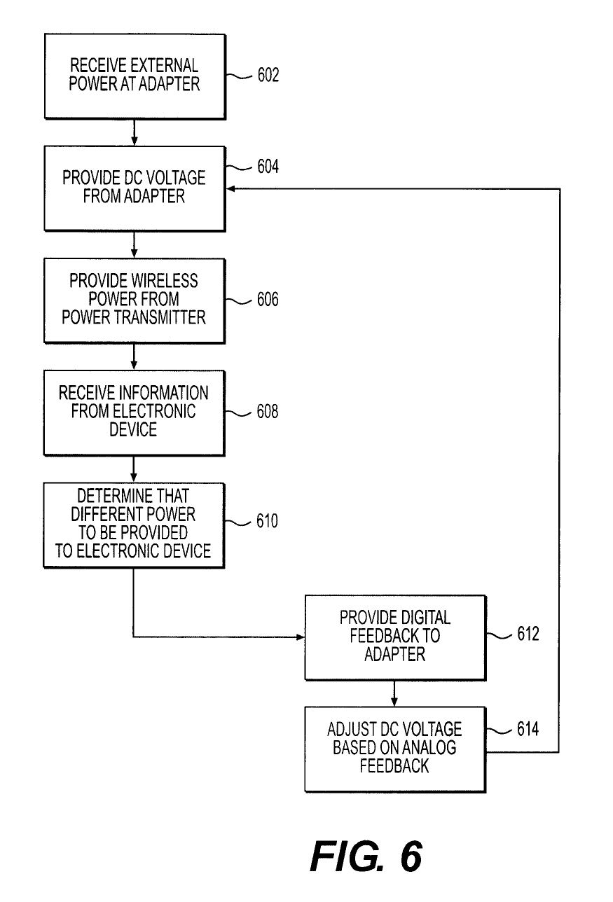

FIG. 6 is a flowchart showing operations according to an example embodiment. Other operations, orders of operations and embodiments may also be provided.

More specifically, FIG. 6 shows a plurality of operations that may be performed by the adapter and charging structure of FIG. 5, for example.

Operation 602 may include to receive an external power at an adapter. For example, the AC/DC adapter 550 may receive an external power 15 from an external power source.

Operation 604 may include to provide a DC voltage from the adapter. For example, the AC/DC adapter 550 may provide a DC voltage to the charging device 400.

Operation 606 may include to provide wireless power from a power transmitter. For example, the power transmitter 240 may provide the wireless power to a receiving device, such as an electronic device.

Operation 608 may include to receive information from an electronic device. For example, the wireless communication device 250 may receive power information from the electronic device.

Operation 610 may include to determine that a different power is to be provided to the electronic device. For example, the microcontroller 260 may determine (from the received power information) that a different power is to be provided to the electronic device.

Operation 612 may include to provide a digital feedback to the adapter. For example, the microcontroller 260 may provide a digital feedback signal to the adapter 550.

Operation 614 may include to adjust the DC voltage output from the adapter based on the digital feedback signal. For example, the AC/DC adapter 550 may adjust the DC voltage that is to be output (from the AC/DC adapter 550) based on the digital feedback signal.

Operations may then return to operation 604 where the DC voltage is output from the AC/DC adapter 550 to the charging device 400. The other operations of the flow chart may then be performed.

The following examples pertain to further embodiments.

Example 1 is a charging system comprising: an adapter to receive an external power and to provide an output voltage; and a charging device to receive the output voltage from the adapter and to provide a wireless power based on the output voltage, the charging device including: a power transmitter to transmit the wireless power based at least in part on the output voltage of the adapter, a wireless communication device to receive power information from an external electronic device, and a feedback device to receive the power information and to provide a feedback signal to the adapter based on the power information, and the adapter to adjust the output voltage based on the feedback signal.

In Example 2, the subject matter of Example 1 can optionally include the feedback device includes a controller to receive the power information and to provide the feedback signal to the adapter based on the power information.

In Example 3, the subject matter of Example 1 and Example 2 can optionally include the feedback signal is a digital signal.

In Example 4, the subject matter of Example 1 and Example 3 can optionally include the digital signal is provided from the controller to the adapter.

In Example 5, the subject matter of Example 1 and Example 4 can optionally include a connector between the controller and the adapter, and the digital signal to be provided from the controller to the adapter via the connector.

In Example 6, the subject matter of Example 1 and Example 5 can optionally include the connector is an I2C interface.

In Example 7, the subject matter of Example 1 can optionally include the feedback device includes a controller and a digital potentiometer, the controller to receive the power information and to provide a command to the digital potentiometer based on the power information, and the digital potentiometer to provide the feedback signal to the adapter.

In Example 8, the subject matter of Example 1 and Example 7 can optionally include the feedback signal is an analog signal.

In Example 9, the subject matter of Example 1 and Example 8 can optionally include the analog signal is provided from the digital potentiometer to the adapter.

In Example 10, the subject matter of Example 1 and Example 7 can optionally include a connector between the controller and the digital potentiometer, and the command is to be provided from the controller to the digital potentiometer via the connector.

In Example 11, the subject matter of Example 1 and Example 10 can optionally include the connector is an I2C interface.

In Example 12, the subject matter of Example 1 and Example 7 can optionally include the digital potentiometer is a programmable resistor divider.

In Example 13, the subject matter of Example 1 can optionally include the adapter is an alternate current/direct current (AC/DC) adapter.

In Example 14, the subject matter of Example 1 can optionally include the power information is information to increase the wireless power from the power transmitter.

In Example 15, the subject matter of Example 1 can optionally include the power information is information to decrease the wireless power from the power transmitter.

In Example 16, the subject matter of Example 1 can optionally include the charging device further including a power amplifier to receive the output voltage directly from the adapter, and to provide an alternate current (AC) signal based on the received output voltage, and the power transmitter to transmit the wireless power based at least in part on the AC signal.

In Example 17, the subject matter of Example 1 and Example 16 can optionally include the charging device includes at least one connection to the power amplifier without using a voltage regulator.

In Example 18, the subject matter of Example 1 can optionally include the power transmitter includes at least one induction coil.

Example 19 is a wireless charging system comprising: an alternate current/direct current (AC/DC) adapter to provide a DC voltage signal, and the AC/DC adapter to adjust the DC voltage signal based on feedback; a power transmitter to provide a wireless power based at least in part on the DC voltage signal; a wireless communication device to receive power information from the external electronic device; and a feedback device to provide the feedback based on the received power information.

In Example 20, the subject matter of Example 19 can optionally include a controller to receive the power information and to provide the feedback to the AC/DC adapter based on the power information.

In Example 21, the subject matter of Example 19 and Example 20 can optionally include the feedback is provided within a digital signal.

In Example 22, the subject matter of Example 19 and Example 21 can optionally include the digital signal is provided from the controller to the AC/DC adapter.

In Example 23, the subject matter of Example 19 and Example 22 can optionally include a connector between the controller and the AC/DC adapter, and the digital signal to be provided from the controller to the AC/DC adapter via the connector.

In Example 24, the subject matter of Example 19 and Example 23 can optionally include the connector is an I2C interface.

In Example 25, the subject matter of Example 19 can optionally include the feedback device includes a controller and a digital potentiometer, the controller to receive the power information and to provide a command to the digital potentiometer based on the power information, and the digital potentiometer to provide the feedback to the AC/DC adapter.

In Example 26, the subject matter of Example 19 and Example 25 can optionally include the feedback is within an analog signal.

In Example 27, the subject matter of Example 19 and Example 26 can optionally include the analog signal is provided from the digital potentiometer to the AC/DC adapter.

In Example 28, the subject matter of Example 19 and Example 25 can optionally include a connector between the controller and the digital potentiometer, and the command is to be provided from the controller to the digital potentiometer via the connector.

In Example 29, the subject matter of Example 19 and Example 28 can optionally include the connector is an I2C interface.

In Example 30, the subject matter of Example 19 and Example 25 can optionally include the digital potentiometer is a programmable resistor divider.

In Example 31, the subject matter of Example 19 can optionally include the power information is information to increase the wireless power from the power transmitter.

In Example 32, the subject matter of Example 19 can optionally include the power information is information to decrease the wireless power from the power transmitter.

In Example 33, the subject matter of Example 19 can optionally include a power amplifier to receive the DC voltage signal directly from the AC/DC adapter, and to provide an alternate current (AC) signal based on the received DC voltage signal, and the power transmitter to transmit the wireless power based at least in part on the AC signal.

In Example 34, the subject matter of Example 19 and Example 33 can optionally include at least one connector is provided between the AC/DC adapter and the power amplifier without using a voltage regulator.

In Example 35, the subject matter of Example 19 can optionally include the power transmitter includes at least one induction coil.

Example 36 is a wireless charging system comprising: an alternate current/direct current (AC/DC) adapter to provide a DC voltage signal, and the AC/DC adapter to adjust the DC voltage signal based on feedback; power means for providing a wireless power based at least in part on the DC voltage signal from the AC/DC adapter; communicating means for receiving power information from an external electronic device; and feedback means for providing the feedback based on the received power information.

In Example 37, the subject matter of Example 36 can optionally include the feedback means includes a controller to receive the power information and to provide the feedback to the AC/DC adapter based on the power information.

In Example 38, the subject matter of Example 36 and Example 37 can optionally include the feedback is within a digital signal.

In Example 39, the subject matter of Example 36 and Example 38 can optionally include the digital signal is provided from the controller to the AC/DC adapter.

In Example 40, the subject matter of Example 36 and Example 39 can optionally include a connector between the controller and the AC/DC adapter, and the digital signal to be provided from the controller to the AC/DC adapter via the connector.

In Example 41, the subject matter of Example 36 and Example 40 can optionally include the connector is an I2C connector.

In Example 42, the subject matter of Example 36 can optionally include the feedback means includes a controller and a digital potentiometer, the controller to receive the power information and to provide a command signal to the digital potentiometer based on the power information, and the digital potentiometer to provide the feedback to the AC/DC adapter.

In Example 43, the subject matter of Example 36 and Example 42 can optionally include the feedback is within an analog signal.

In Example 44, the subject matter of Example 36 and Example 43 can optionally include the analog signal is provided from the digital potentiometer to the AC/DC adapter

In Example 45, the subject matter of Example 36 and Example 42 can optionally include a connector between the controller and the digital potentiometer, and the command is to be provided from the controller to the digital potentiometer via the connector.

In Example 46, the subject matter of Example 36 and Example 45 can optionally include the connector is an I2C interface.

In Example 47, the subject matter of Example 36 and Example 42 can optionally include the digital potentiometer is a programmable resistor divider.

In Example 48, the subject matter of Example 36 can optionally include the power information is information to increase the wireless power from the power means.

In Example 49, the subject matter of Example 36 can optionally include the power information is information to decrease the wireless power from the power means.

In Example 50, the subject matter of Example 36 can optionally include a power amplifier to receive the DC voltage signal directly from the AC/DC adapter, and to provide an alternate current (AC) signal based on the received DC voltage signal, and the power means to transmit the wireless power based at least in part on the AC signal.

In Example 51, the subject matter of Example 36 and Example 50 can optionally include at least one connector is provided between the AC/DC adapter and the power amplifier without using a voltage regulator.

In Example 52, the subject matter of Example 36 can optionally include the power means includes at least one induction coil.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A charging system comprising:
an adapter to receive an external power and to provide an output voltage; and
a charging device to receive the output voltage from the adapter and to provide a wireless power based on the output voltage, the charging device including:
a power transmitter to transmit the wireless power based at least in part on the output voltage of the adapter,
a wireless communication device to receive power information from an external electronic device, and
a feedback device to receive the power information and to provide a feedback signal to the adapter based on the power information, and the adapter to adjust the output voltage based on the feedback signal.

2. The charging system of claim 1, wherein the feedback device includes a controller to receive the power information and to provide the feedback signal to the adapter based on the power information.

3. The charging system of claim 2, wherein the feedback signal is a digital signal.

4. The charging system of claim 1, wherein the feedback device includes a controller and a digital potentiometer, the controller to receive the power information and to provide a command to the digital potentiometer based on the power information, and the digital potentiometer to provide the feedback signal to the adapter.

5. The charging system of claim 4, wherein the feedback signal is an analog signal.

6. The charging system of claim 4, wherein the digital potentiometer is a programmable resistor divider.

7. The charging system of claim 1, wherein the power information is information to increase the wireless power from the power transmitter.

8. The charging system of claim 1, wherein the power information is information to decrease the wireless power from the power transmitter.

9. The charging system of claim 1, wherein the charging device further including a power amplifier to receive the output voltage directly from the adapter, and to provide an alternate current (AC) signal based on the received output voltage, and the power transmitter to transmit the wireless power based at least in part on the AC signal.

10. The charging system of claim 9, wherein the charging device includes at least one connection to the power amplifier without using a voltage regulator.

11. A wireless charging system comprising:
an alternate current/direct current (AC/DC) adapter to provide a DC voltage signal, and the AC/DC adapter to adjust the DC voltage signal based on feedback;
a power transmitter to provide a wireless power based at least in part on the DC voltage signal;
a wireless communication device to receive power information from the external electronic device; and
a feedback device to provide the feedback based on the received power information.

12. The wireless charging system of claim 11, wherein the feedback device includes a controller to receive the power information and to provide the feedback to the AC/DC adapter based on the power information.

13. The wireless charging system of claim 12, wherein the feedback is provided within a digital signal.

14. The wireless charging system of claim 11, wherein the feedback device includes a controller and a digital potentiometer, the controller to receive the power information and to provide a command to the digital potentiometer based on the power information, and the digital potentiometer to provide the feedback to the AC/DC adapter.

15. The wireless charging system of claim 14, wherein the feedback is within an analog signal.

16. The wireless charging system of claim 11, further comprising a power amplifier to receive the DC voltage signal directly from the AC/DC adapter, and to provide an alternate current (AC) signal based on the received DC voltage signal, and the power transmitter to transmit the wireless power based at least in part on the AC signal.

17. The wireless charging system of claim 16, wherein at least one connector is provided between the AC/DC adapter and the power amplifier without using a voltage regulator.

18. A wireless charging system comprising:
an alternate current/direct current (AC/DC) adapter to provide a DC voltage signal, and the AC/DC adapter to adjust the DC voltage signal based on feedback;
power means for providing a wireless power based at least in part on the DC voltage signal from the AC/DC adapter;
communicating means for receiving power information from an external electronic device; and
feedback means for providing the feedback based on the received power information.

19. The wireless charging system of claim 18, wherein the feedback means includes a controller to receive the power information and to provide the feedback to the AC/DC adapter based on the power information.

20. The wireless charging system of claim 18, wherein the feedback means includes a controller and a digital potentiometer, the controller to receive the power information and to provide a command signal to the digital potentiometer based on the power information, and the digital potentiometer to provide the feedback to the AC/DC adapter.
